(19) United States
(12) Patent Application Publication
(10) Pub. No.: US 2002/0143971 A1
(43) Pub. Date: Oct. 3, 2002

(54) Session resumption in wireless packet data network

(76) Inventors: Rangaprasad Govindarajan, Plano, TX (US); Steven McCutchen, Frisco, TX (US); Jogen Pathak, Dallas, TX (US)

Correspondence Address: R. Scott Rhoades, Strasburger & Price, L.L.P., 901 Main Street, Suite 4300, Dallas, TX, 75202-3794, US

(21) Appl. No.: 09/875,522

(22) Filed: Jun. 6, 2001

Related U.S. Application Data
(63) Continuation-in-part of application No. 09/839,830, filed on Apr. 19, 2001.
(63) Continuation-in-part of application No. 09/718,723, filed on Nov. 22, 2000.
(60) Provisional application No. 60/251,929, filed on Dec. 7, 2000.
(60) Provisional application No. 60/192,169, filed on Mar. 27, 2000.

(51) Int. Cl. G06F 15/16

(52) U.S. Cl. 709/230

(57) ABSTRACT

A system, method, and apparatus for session resumption in a wireless data network is presented herein. A wireless content switch is placed between the wired network and the mobile station which maintains a session log of pending sessions, including the mobile session, the content server, and status of the session. Wherein the session is interrupted, and resumed, the session log is examined for a record associated with the resumed session. Wherein a record is found for the resumed session, the wireless content switch modifies commands to permit session resumption at the point of interruption, in contrast with restarting the session.

### RELATED APPLICATIONS

This application claims priority to U.S. patent application Ser. No. ______, entitled “System and Method for Wireless Packet Data Content Switch”, Attorney Docket Number 014654.0003, filed on Apr. 17, 2001, U.S. patent application Ser. No. 09/718,713, entitled “System and Method for Wireless Content Switch,” filed Nov. 22, 2000, and Provisional Patent Application serial No. 60/192,169, filed Dec. 7, 2000, which are commonly owned and assigned with the present application and hereby incorporated by reference for all purposes.

### FIELD

The present application is related to wireless packet data networks, and more particularly to session extension in wireless packet data networks.

### BACKGROUND

Session interruption is a common problem encountered during internet usage. As internet downloads, such as web pages and file transfers increase in size, the likelihood of session interruption increases. An internet session can be interrupted due to failures in the communication medium, the client, and the server, to name a few.

When a session is interrupted during a download, it is not only desirable to resume the session, but it is also desirable to resume the session at the point where the session was interrupted. For example, when a user is downloading a 1 MB file and an interruption occurs after 800 KB of the file has downloaded, it would be desirable to restart the session in a manner that the download can continue, starting from the remaining 200 KB. Resuming the session in such a manner advantageously preserves network bandwidth and provides a faster completed download for the user.

The hypertext transmission protocol (HTTP) is updated to include functionality which allows session resumption at a point during the download wherein the session was initially interrupted. Therefore, a client downloading from a server, wherein both the client and server are equipped with the appropriate version of HTTP, can resume a session interrupted at the point of interruption. A client equipped with the appropriate version of HTTP counts the bytes received during a download. When an interruption occurs, after the session is resumed, the client is aware of the amount of bytes received and can request the download, starting from the remainder of the download.

Recent advances have also provided internet services to wireless terminals. General Packet Radio Service (GPRS) is one of the prevailing standards for the delivery of data services over the wireless air interface. Session interruption during wireless internet sessions is also a common problem because the wireless air interface is particularly susceptible to high bit error rates, environment and other external factors, as well as intermittent link (or transport) failures. Accordingly, session resumption at the point of interrupt is also desirable with wireless internet access.

Wireless clients, such as cellular telephone sets, palm top computers, and personal digital assistants, are generally smaller, have less processing power, and less memory. Placement of session resumption software at the wireless client would consume an undesirable portion of the limited processing power in the wireless client.

Accordingly, it would be beneficial if session resumption could be provided to wireless clients in a manner which conserves the resources of the wireless clients.

### SUMMARY

Presented herein is a system, method, and apparatus for providing session resumption in a wireless packet data network. An wireless content switch interconnected between the wired network and the wireless network maintains a log of active sessions, content downloading, requesting wireless client, and amount downloaded. When a session is interrupted and resumed, the wireless client retransmits the request for downloading the content. The wireless content switch associates the new request for the content with the initial session in the log. Responsive thereto, the wireless content switch builds a new request for the content, beginning at the point that the initial session was terminated.

### BRIEF DESCRIPTION OF THE DRAWINGS

FIG. 1 is a block diagram of an exemplary system for delivering data packets to a wireless client;

FIG. 2 is a block diagram of sequential data;

FIG. 3 is a block diagram of an exemplary packet;

FIG. 4 is a block diagram of an exemplary session log;

FIG. 5 is a flow diagram the operation of the internet content switch; and

FIG. 6 is a flow diagram describing an exemplary hardware environment wherein the present invention can be practiced.

### DETAILED DESCRIPTION OF THE DRAWINGS

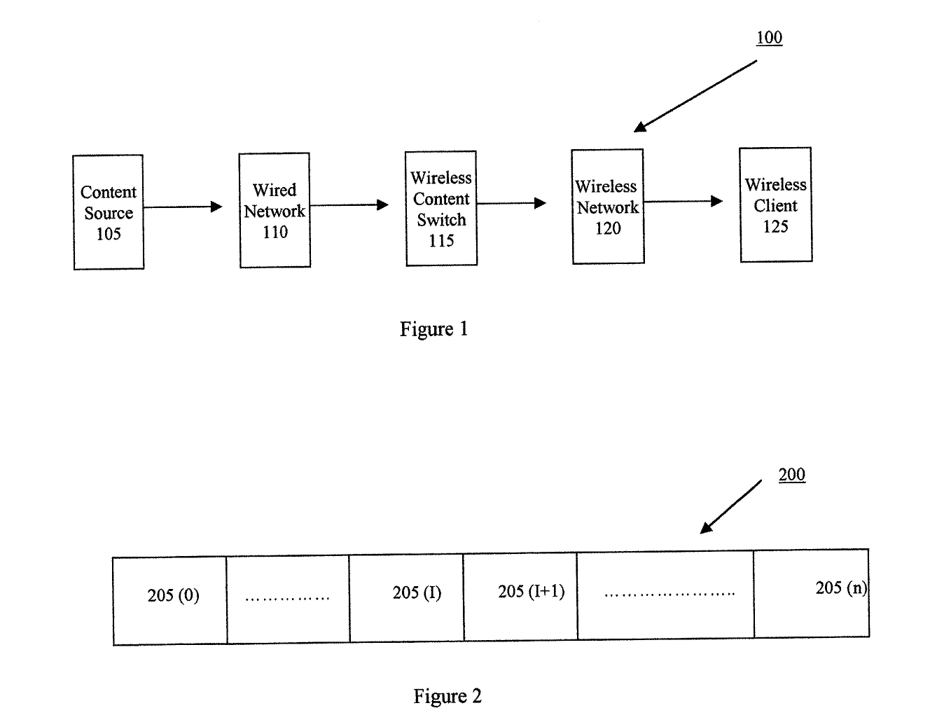

Referring now to FIG. 1, there is illustrated a conceptual diagram of a communication system, referenced generally by the numeric designation 100, for sending sequential data from content source 105 to a wireless client 125. The content source 105 is a server providing information which can comprise, for example, a web server, email server, ftp server, database server, streaming audio/video server, or an application server. The sequential data is data from the content source 105 and can comprise, for example, web pages, emails, downloadable files, audio files, or video files.

Information from the content source 105 is transmitted in the form of numbered data packets, comprising the sequential data, over a wired network 110, wherein each data packet is associated with a packet number. The wired network 110 is a packet data wireline communication system which can comprise, for example, a local area network, a wide area network, or the Internet. The wired network 110 transmits the data packets to a wireless network 120 associated with the wireless client 125 via a wireless content switch 115.

The wireless network 120 comprises any communication network which can transmit packet data over a wireless air interface. For example, the wireless network 120 can comprise cellular telephone networks, such as the Global System for Mobile Communications (GSM) or Personal Communication System (PCS), equipped to transmit packet data in accordance with the General Packet Radio Service (GPRS) or EDGE protocols. The wireless network 120 transmits the packet data over the wireless air interface to the wireless client 125.

The wireless content switch 115 receives GPRS tunneling protocol format packet data and can determine additional processing that may be required based upon the wireless client 125, and the type of content in the packet, priority data, quality of service data, multicasting functionality, or other suitable functions.

Referring now to FIG. 2, there is illustrated a block diagram describing the sequential data, referred to generally by the numeric reference 200. A wireless client 125 can download the sequential data 200 during a session. The sequential data 200 is divided into any number of partitions 205. Each partition in a data packet to the wireless client 125. The data packets transport the data partitions 205 towards the wireless client 125 in a generally serial manner. Accordingly, a partition, e.g., partition 205(n), comprising the highest sequential data is transported at a later time than a partition, e.g., partition 205(0) comprising lower sequential data.

Session interruption during the session is a common problem because the wireless air interface is particularly susceptible to high bit error rates and intermittent failures. Wherein a session is interrupted during download of sequential data 200, upon resumption of the session, the session begins downloading at the point where the session was interrupted. For example, wherein a session interruption occurs after the wireless client 125 has received data packets comprising partitions 205(0) . . . 205(I), data packets starting with the data packet comprising partition 205(I+1) are downloaded, as opposed to partition 205(0), upon resumption of the session. The foregoing advantageously preserves bandwidth, as well as providing a faster download for the user.

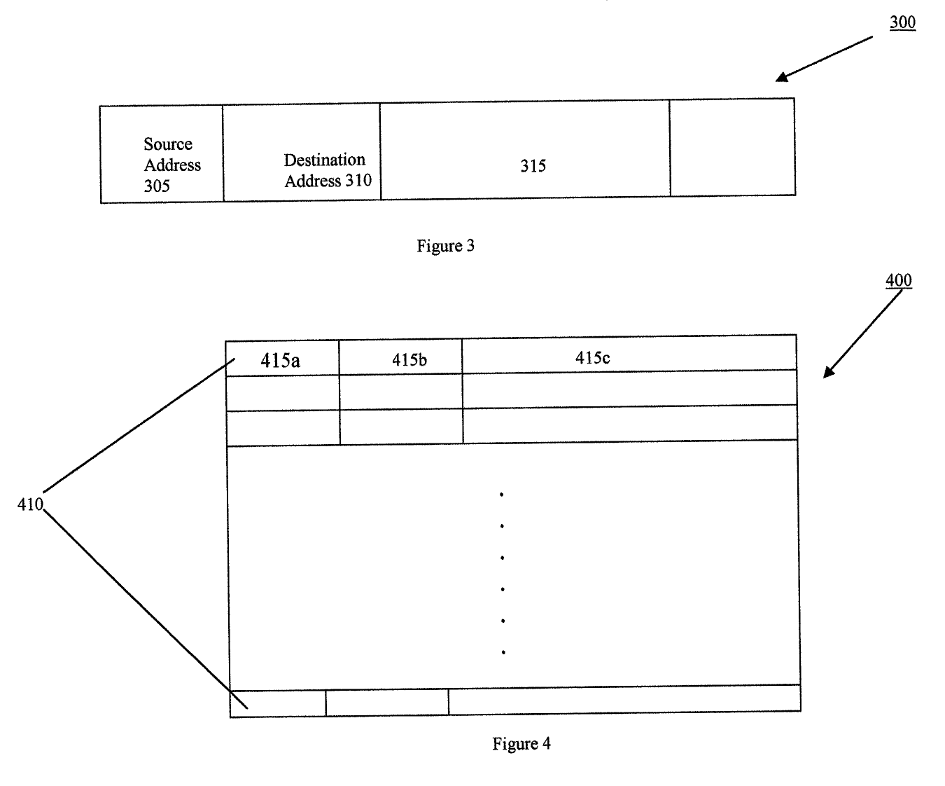

Referring now to FIG. 3, there is illustrated a block diagram of an exemplary data packet, referred to generally by the numeric reference 300. The data packet 300 can include a source address 305, a destination address 310, and payload 315. The source address 305 is the address of the terminal sending the data packet 300, wherein the destination address is the address of the terminal receiving the data packet 300. The payload 315 is the actual data for transmission. Wherein wireless client 125 downloads sequential data 200 from the content source 105, the content source is identified by the source address, the wireless client 125 is identified by the destination address 310, and a partition 205 is carried in the payload 315.

As noted above, data packets 300 are transmitted from the content source 105 to the wireless client 125 via the wireless content switch 115. By examining and monitoring the source address 305, the destination 310, and the amount of payload 315, the wireless content switch can determine the particular partition 205(I) that is transmitted. Furthermore, wherein an initial session is interrupted after receipt of partition 205(I) and resumed at the wireless client 125, the wireless client 125 will retransmit a request for the sequential data 200. The wireless content switch 115 can correlate the request with the activity monitored, and determine the next partition 205(I+1) to be received after the initial session was terminated.

Referring now to FIG. 4, there is illustrated a block diagram of a wireless content switch 115 comprising an active session log, referred to generally by the numeric reference 400. The active session log 400 includes any number of records 410. Each record 410 is associated with a particular wireless client 125 session during which the particular wireless client 125 downloads sequential data.

Each record 410 contains identifiers identifying the wireless client 415a, the sequential data 415b, and the amount of data received during the session 415c and is stored when the session is initiated. As each data packet 300 is received the source address 305, the destination address 310, and the payload 315 are examined. Wherein the destination address 310 corresponds to a wireless client identifier 415a, and the source address 305 corresponds to sequential data identifier 415b, the identifier identifying the amount of data received during the session 415c is incremented by the amount of data in the payload 315 of the data packet 200.

Wherein a session is interrupted, upon resumption of the session, the wireless client 125 retransmits the request for the sequential data. The request is transmitted to the content source 105 via the internet content switch 115. When the internet content switch 115 receives the request from the wireless client 125 after session resumption, the internet content switch 115 retrieves the record 410 associated with the wireless client 125, the content source 105, and the sequential data 200, including the identifier identifying the amount of data that was received. Because the identifier identifying the amount of data received 415c was updated when the last data packet 300 was received prior to the interrupt of the initial session, the wireless content switch 115 can determine the last partition 205(I) received. Accordingly, the wireless content switch 115 builds a request for a portion of the sequential data 200, beginning with partition 200(I+1). In this manner, the wireless content switch 115 causes the download to continue, beginning with partition 200(I+1) as opposed to 200(0).

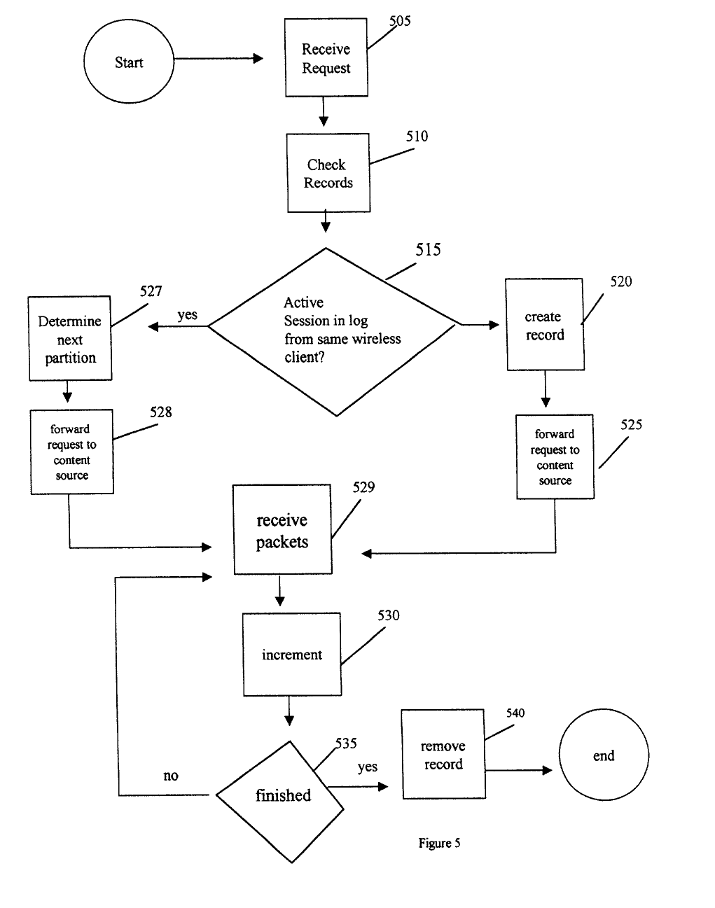

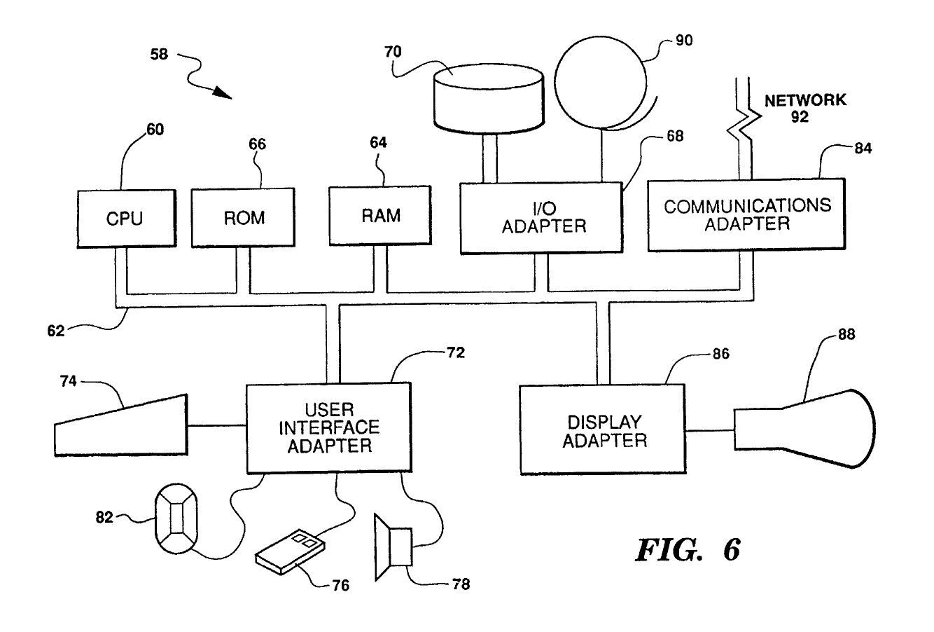

Referring now to FIG. 5, there is illustrated a flow diagram describing the operation of the wireless content switch 115 responsive to receipt of a request. At step 505 the wireless content switch 115 receives a request from wireless client 125 for sequential data 200 residing at content source 105. At step 510, the wireless content switch checks the records 410 of the active session log 400 to determine if there is a corresponding active session requesting the same sequential data 200 from the same wireless client 125 (step 515).

Wherein no such record 410 is found, a record 410 is created (step 520) containing identifiers identifying the wireless client 125, the sequential data 200 requested, and the amount of data received is initialized to zero. The request is then forwarded to the content source 105 (step 525).

Wherein a record 410 is found, the identifier identifying the amount of data received is used to determine (step 527) the next partition 205(I+1) of sequential data to transmit to the wireless client and the wireless content switch transmits a request (step 528) for a portion of the sequential data 200 beginning at partition 205(I+1).

Data packets 300 containing partitions 205 are received (step 529) and at step 530, the identifier identifying the amount of data received 415c is incremented by the amount of data contained in the payload of the data packet. Steps 529 and 530 are repeated until the download of the sequential data 200 is finished (step 535). After the download of the sequential data is finished, the record 410 associated with the session is removed from the active session log (step 540).

Referring now to FIG. 6, a representative hardware environment for practicing the present invention is depicted and illustrates a typical hardware configuration of a computer information handling system 58 in accordance with the subject invention, having at least one central processing unit (CPU) 60. CPU 60 is interconnected via system bus 12 to random access memory (RAM) 64, read only memory (ROM) 66, and input/output (I/O) adapter 68 for connecting peripheral devices such as disc units 70 and tape drives 90 to bus 62, user interface adapter 72 for connecting keyboard 74, mouse 76 having button 67, speaker 78, microphone 82, and/or other user interfaced devices such as a touch screen device (not shown) to bus 62, communication adapter 84 for connecting the information handling system to a data processing network 92, and display adapter 86 for connecting bus 62 to display device 88.

Although the foregoing detailed description has certain degree of particularity, it should be recognized that elements thereof may be altered by persons skilled in the art without departing from the spirit and scope of the invention. One embodiment can be implemented as sets of instructions resident in the random access memory 64 of one or more computer systems configured generally as described in FIG. 6. Until required by the computer system, the set of instructions may be stored in another computer readable memory, for example in a hard disk drive, or in a removable memory such as an optical disk for eventual use in a CD-ROM drive or a floppy disk for eventual use in a floppy disk drive. Further, the set of instructions can be stored in the memory of another computer and transmitted over a local area network or a wide area network, such as the Internet, when desired by the user. One skilled in the art would appreciate that the physical storage of the sets of instructions physically changes the medium upon which it is stored electrically, magnetically, or chemically so that the medium carries computer readable information. The invention is limited only by the following claims and their equivalents.

What is claimed is:

1. A method for transmitting sequential data to a wireless client, said method comprising:
transmitting a first portion of the sequential data during a first session with the wireless client; and
transmitting a second portion of the sequential data at the commencement of a second session with the wireless client, wherein the second portion of the sequential data begins substantially at the end of the first portion of the sequential data.

2. The method of claim 1, wherein the sequential data comprises a web page.

3. The method of claim 1, wherein the sequential data comprises a file.

4. The method of claim 1, wherein transmitting the first portion further comprises:
receiving a request from the wireless client to download the sequential data; and
storing an identifier identifying said wireless client, and a corresponding identifier identifying said sequential data into a table.

5. The method of claim 4, wherein transmitting the first portion further comprises:
associating an identifier identifying amount of data received with the identifiers identifying the wireless client and the sequential data;
receiving at least one data packet; and
incrementing the identifier identifying the amount of data received with the total data of said at least one packet.

6. The method of claim 5, wherein incrementing the identifier identifying the amount of data received further comprises:
examining a payload portion of the at least one data packet.

7. The method of claim 5, wherein transmitting the second portion further comprises:
receiving a second request from the wireless client to download the sequential data; and
locating the identifier identifying the wireless client, the sequential data, and the amount of data received.

8. The method of claim 7, wherein transmitting the second portion further comprises:
building a request for the second portion of the sequential data.

9. A method for transmitting sequential data to a wireless client, said method comprising:
receiving a request for said sequential data from the wireless client; and
searching a table, said table storing a plurality of records, wherein each record comprises an identifier identifying wireless clients an identifier identifying sequential data, and an identifier identifying amount of data received.

10. The method of claim 9, further comprising:
building a request for a portion of the sequential data wherein a particular record comprises an identifier identifying the wireless client, wherein the portion of the sequential data begins at an address in the sequential data related to the amount of data received.

11. The method of claim 9, further comprising:
wherein none of the plurality of records comprises an identifier identifying the wireless client, storing a record comprising an identifier identifying the wireless client, an identifier identifying the sequential data, and an identifier identifying amount of data received.

12. A communications system for transmitting sequential data to a wireless client, said system comprising:
a wired network for receiving data packets from a content source and transmitting the data packets to the wireless network, wherein the data packets comprise the sequential information;
a wireless network for transmitting at least a first portion of the data packets to the wireless client during a first session; and
a wireless content switch for totaling amount of data in the portion of the data packets.

13. The communications system of claim 12, wherein the wireless network transmits a second portion of the data packets to the wireless content during a second session, wherein the second portion of data packets begin substantially at the end of the first portion of data packets.

14. The communications system of claim 12, wherein the wireless content switch further comprises:
a table for storing an identifier identifying the wireless client, an identifier identifying the sequential data, and an identifier identifying the total amount of data in the portion of the data packets.

15. The communication system of claim 12, wherein the sequential data comprises a web page.

16. The communication system of claim 12, wherein the sequential data comprises a file.

17. A wireless content switch for transmitting sequential data, said wireless content switch comprising:
a first memory for storing a plurality of records, wherein each record comprises an identifier identifying wireless clients an identifier identifying sequential data, and an identifier identifying amount of data received;
a second memory for storing a plurality of executable instructions, wherein the executable instructions comprise:
receiving a request for said sequential data from the wireless client; and
searching the first memory for a record comprising an identifier identifying the wireless client; and
a processor for executing the plurality of executable instructions.

18. The wireless content switch of claim 17, wherein the plurality of executable instructions further comprises:
building a request for a portion of the sequential data wherein a particular record comprises an identifier identifying the wireless client, wherein the portion of the sequential data begins at an address in the sequential data related to the amount of data received.

19. The internet content switch of claim 18, wherein the plurality of executable instructions further comprise:
wherein none of the plurality of records comprises an identifier identifying the wireless client, storing a record comprising an identifier identifying the wireless client, an identifier identifying the sequential data, and an identifier identifying amount of data received.
